(19) United States
(12) Patent Application Publication
(10) Pub. No.: US 2005/0190641 A1
(43) Pub. Date: Sep. 1, 2005

(54) Method and system for mixing fingernail polish

(76) Inventor: John Wayne Countz, Wichita, KS (US)

Correspondence Address: John Wayne Countz, 1414 Old County Home Road, Tarboro, NC, 27886, US

(21) Appl. No.: 10/788,834

(22) Filed: Feb. 28, 2004

(51) Int. Cl. B01F 11/00

(52) U.S. Cl. 366/110; 366/128

(57) ABSTRACT

A novel system and method for mixing fingernail polish within its original retail bottle, before its initial use, as well as, before all subsequent uses. A system and method of mixing and or homogenizing fingernail polish and or similar solutions in such a way as to limit the introduction of tiny air bubbles within said solution, which are commonly present after manually mixing, causing surface finish problems during application and drying. A novel and useful system for single-handed operation, featuring an automatic cycle start and mixing cycle control as well as being relatively compact and portable.

### FIELD OF THE INVENTION

The present invention relates generally to a system and method for mixing fingernail polish. More specifically, the present invention relates to a system and method for mixing and or re-homogenizing fingernail polish within the retail package or bottle before its initial use and more commonly before subsequent uses.

1. Background of the Invention

Over time, most fingernail polish solutions or suspensions tend to separate into various phases according to the specific gravities of the constituents which have been combined to formulate said solutions or suspensions, thereby requiring re-homogenizing or mixing to achieve their intended consistency prior to use.

Generally fingernail polish is mixed by means of manual agitation in a back and forth or up and down movement of the hand with the bottle closed and held between the thumb and fingers of the hand being moved. This relatively uncontrolled and subjective manual mixing action, often leads to the formation of small bubbles within the polish, which cause undesirable effects on the surface finish after drying as well as difficulties in application.

In the professional arena of nail care there remains a clear need for a system and method by which the nail technician can evenly and consistently mix bottles of fingernail polish many times each hour without suffering the ergonomic stress of repeated manual mixing motions.

2. Description of the Prior Art

While the prior art listed below demonstrates a myriad of different methods for mixing paints and cosmetics, those in the art will appreciate the unique applications embodied within the present invention.

U.S. Pat. No. 5,778,901 issued Jul. 14, 1998, to Sandra L. Abrahamian, describes a nail polish kit for mixing custom solutions by a plurality of pigments.

U.S. Pat. No. 4,714,084 issued Dec. 22, 1987, to a Craig Berry & Marc Bennett, describes a method for simultaneously applying and blending cosmetics.

U.S. Pat. No. 5,322,358 issued Jun. 21, 1994, to Denise Coho & Eddy Peiffer, describes a portable cosmetic shaker.

U.S. Pat. No. 4,842,415 issued Jun. 27, 1998, to Michael R. Cane & Michael H. Groves, describes a paint shaker for in-store paint tinting.

U.S. Pat. No. 4,497,581 issued Feb. 5, 1985 to Herbert L. Miller, describes a paint shaker for agitating and mixing paint and the like.

U.S. Pat. No. 4,422,768 issued Dec. 27, 1983 to Donald F. Solomon, describes a paint can shaker which includes springs acting between the frame and a supporting surface to enable the carrier to undergo rolling vibratory motion relative to the supporting surface.

It is understood that there are many methods available for the mixing of paints, lacquers, enamels, and liquid acrylics such as fingernail polish, however those methods are generally for large quantities and are unsuitable for mixing a small single bottle of solution and are designed to produce violent actions within solutions which are unsuitable for the mixing of fingernail polish in as much as the introduction of air bubbles is undesirable. Available units are have either been designed for broad and generic across the board mixing applications such as cosmetics in general or paints in general but fail to address the specific requirements needed to correctly remix fingernail polish prior to its application to the fingernail. While some available units could be useful in a commercial setting, these units are impractical for home and or personal use based upon size, complexity, lack of portability and increased cost.

Therefore, there remains a need for a controlled and automatic system of consistent and even mixing or homogenizing fingernail polish within the retail bottle before each use, which does not cause or tend to introduce excessive air or gas bubble formations within the said fingernail polish suspension through violent agitation. There further remains a need for a system and method as mentioned above that is cost effective to produce and offer in the retail and personal appliance market.

### BRIEF SUMMARY OF THE INVENTION

The present invention provides a system and method for mixing or homogenizing fingernail polish while inside its original retail bottle, before the first usage as well as before each subsequent use. The current invention further provides for a method mixing and or homogenizing which minimizes the formation of undesirable bubbles within the solution during the mixing operation.

The system of the present invention generally comprises five main components: a first component, the frame, to provide for a structural body in which the mechanism may operate, a second component, the elastomeric mixing platform to control the gyration of the fingernail polish bottle during mixing, and a third component, the cycle trigger for triggering or starting the mixing cycle upon bottle insertion, a fourth component, the cycle timer logic for controlling length of the mixing operation and a fifth component, a structural non-skid base within which the batteries and electronics are stored. These terms are used as reference terms only and are not intended to be descriptive or limiting.

The frame is comprised of a cylinder with structural support beams running down the inside wall of the cylinder which allow for the mounting of the mixing mechanism concentric to and within the said cylinder.

The elastomeric mixing platform component comprises the work piece holding device, the motor plate and the motor. The work piece holding device comprises a cylindrical plug of polystyrene foam with a specially designed oval shaped cavity cut from the center of the plug along the cylindrical axis so as to form an oval hollow center through the plug from top to bottom. The specially designed oval cutout is shaped in such a way as to accept the reasonable insertion of the vast majority of retail fingernail polish bottle shapes while maintaining sufficient elasticity to keep the bottle secure while mixing. The work piece holding device is fixed to the top surface of the motor plate. The motor plate, for the purpose of description we will say, is a round disc with four anchor points located near or along its outer perimeter by which the plate is suspended along a plane by elastic bands stretched along the same plane or parallel to the plate's top surface with their opposing ends being anchored to the larger diameter of the frame component; said motor plate also having a small rotating motor mounted so that the rotating shaft of the motor is perpendicular to and beneath the motor plate's flat planar top surface. Said motor having an offset weight mounted on its rotating shaft as to cause gyration about the perpendicular centerline axis while the motor shaft is rotating. The work piece holding device, aside from holding the bottle of fingernail polish, also acts as a physical travel limiting and dampening control which limits the formation of undesirable air bubbles during the mixing operation by dampening the inherently violent gyrations created by the wobbling motor.

The cycle trigger component comprises a magnetic reed switch mounted below the elastomeric mixing platform on the frame body and a permanent magnet mounted to the under-side of the elastomeric mixing platform so that when the platform is pushed down by the insertion of a bottle of fingernail polish it causes the magnet to move sufficiently close to the magnetic reed switch to actuate that magnetic reed switch momentarily causing a closed electrical current path which in turn causes the mixing cycle to be initiated.

In one embodiment the cycle timer component is an electronic circuit referred to in the art as a one-shot timer circuit which provides a means for a repeatable fixed time duration current supply to be applied to the counter-weighted rotating electric motor on the elastomeric mixing platform, causing it to rotate for a fixed time duration after having received a momentary current or voltage trigger from the cycle trigger component. In still another embodiment, the electronic cycle timer also reverses the rotational direction of the mixing motor one or more times during the mixing cycle.

### BREIF DECSRIPTION OF THE DRAWINGS

The detailed description that follows offers features, objects, and advantages apparent in the present invention. It should be understood, however, that the detailed description, while indicating preferred embodiments of the invention, are given by way of illustration only, not limitation. Various changes and modifications within the spirit and scope of the invention will become apparent to those skilled in the art from the detailed description.

Various other objects, features and attendant advantages of the present invention will become fully appreciated as the same becomes better understood when considered in conjunction with the accompanying drawings, in which like reference characters designate the same or similar parts throughout the several views. These drawings are provided for illustration, not limitation.

FIG. 1A illustrates an Exploded Wire-frame View of the present invention, which also includes a callout of the motor plate assembly FIG. 1B.

FIG. 2 illustrates a wire-frame perspective drawing of the elastomeric mixing platform.

FIG. 3 illustrates a solid Cut Away View of the present invention.

FIG. 4 illustrates a perspective view of a fully assembled unit.

### DETAILED DESCRIPTION

The present invention provides a system and method for mixing and or homogenizing bottles of fingernail polish so as to present them for immediate use and application by performing said mixing without introducing the air bubbles into the nail polish solution which so commonly cause surface finish problems during and after application when mixed manually.

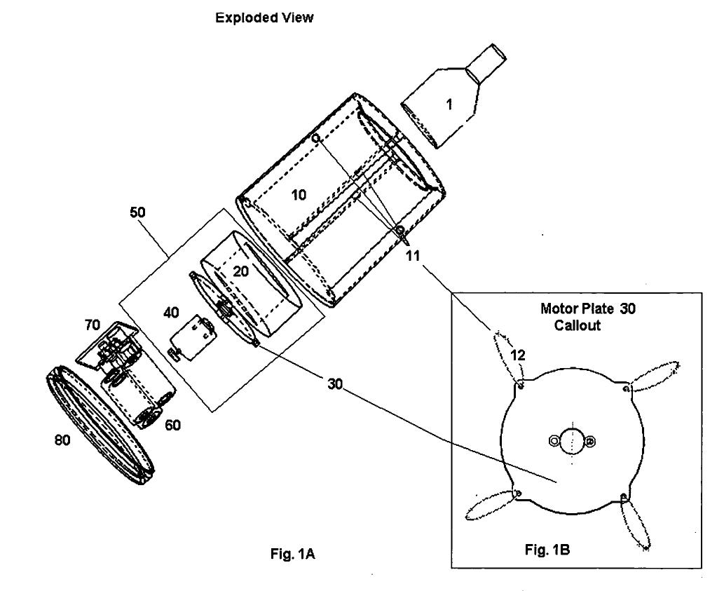

As seen in FIG. 1A, the system of the present invention generally comprises the following components: a first component comprising the upper, outer frame and body 10, with mounting holes 11, for the elastic support bands 12, which support the work piece holding device 20 and motor plate 30, the motor 40, is attached to the underside of the motor plate 30, at its base and it has an offset weight attached to its rotating shaft. All together items 12, 20, 30 and 40 combine to form the elastomeric mixing platform 50. A more detailed callout FIG. 1B is supplied to better illustrate the position of the elastic bands 12 as attached to the motor plate 30. The power source 60, is comprised of three each, C-Cell Batteries. The electronic timer module 70 comprises a printed circuit board with the necessary electronics to control mixing cycle time by virtue of controlling the current flow to the motor 40 after having received the appropriate start signal from the cycle trigger assembly “not shown” which comprises a permanent magnet fixed to the bottom of the elastomeric mixing platform 50, which when said motor plate is pressed in a downward direction, as it would be during the insertion of a bottle of fingernail polish, moves sufficiently close to a magnetic reed switch to cause said switch to close and send a current signal to the electronic timer module 70. The base cover 80 provides structural completion of the body and frame as well as a non-skid base foundation during mixing.

The bottle of fingernail polish 1, is shown for illustrative purposes only and is not a part of the present invention. Wiring is not shown in the mechanical drawing but is assumed to be operational as described, such that those skilled in the art will fully appreciate and understand the functionality forthwith. Also not show is the optional battery eliminator and power jack which allows the unit to be operated by a standard household power source, for example 120V A-C 50/60 Hz etc.

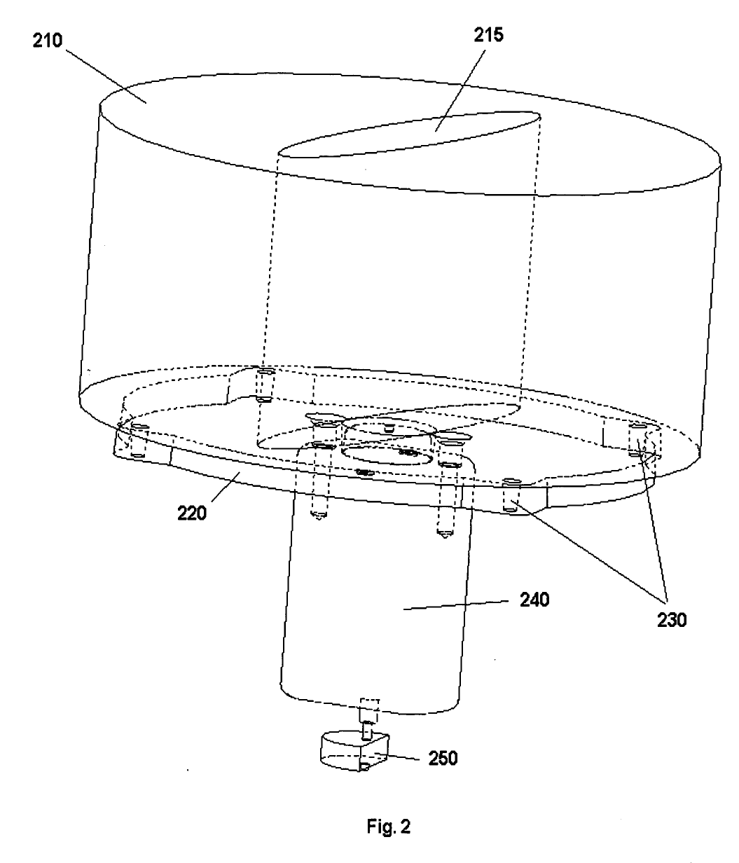

FIG. 2 is a wire-frame perspective illustration of the elastomeric mixing platform sub-assembly. Not show are the elastic bands illustrated in FIG. 1B. The foam work piece holding device 210, with the specially shaped cutout 215, is fixed to the motor plate 220. The elastic band anchor points 230 are clearly visible in this illustration. The rear of the motor 240, is fixed to the motor plate 220 with two screws and the offset weight 250, is press-fit onto the motor shaft. The upper rim and sides of the foam work piece holding device act as a physical travel limit and dampener during gyration or mixing.

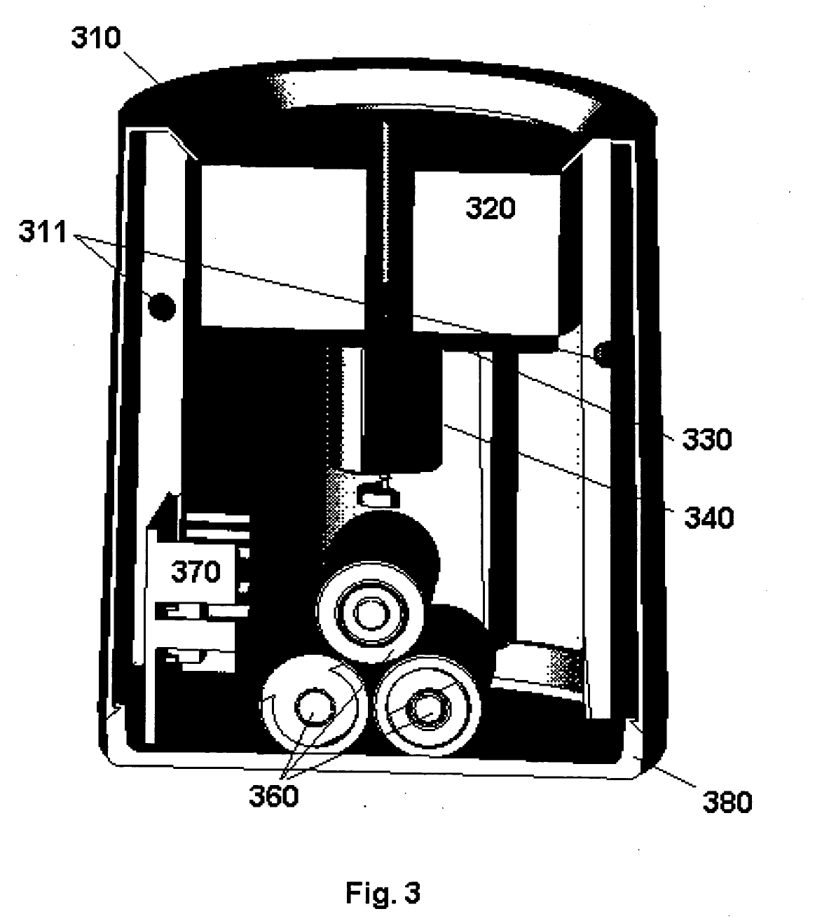

FIG. 3 is a solid cut-away image illustrating the same components shown in FIG. 1A, vertically sliced through near the center to allow for an assembled perspective and layout of said unit. The frame 310 with the internal ribs which have holes 311, cut out to allow for the mounting of the outer ends of the elastic bands to the frame body. The foam work piece holding device 320, fixed to the motor plate 330, which has also a counter weighted motor 340, attached to its base, the combination thereof when combined with the elastic mounting bands comprise the elastomeric mixing platform sub-assembly. Below said sub-assembly is shown, an area housing the batteries 360, the electronic timer module 370, and is structurally completed by the unit base 380.

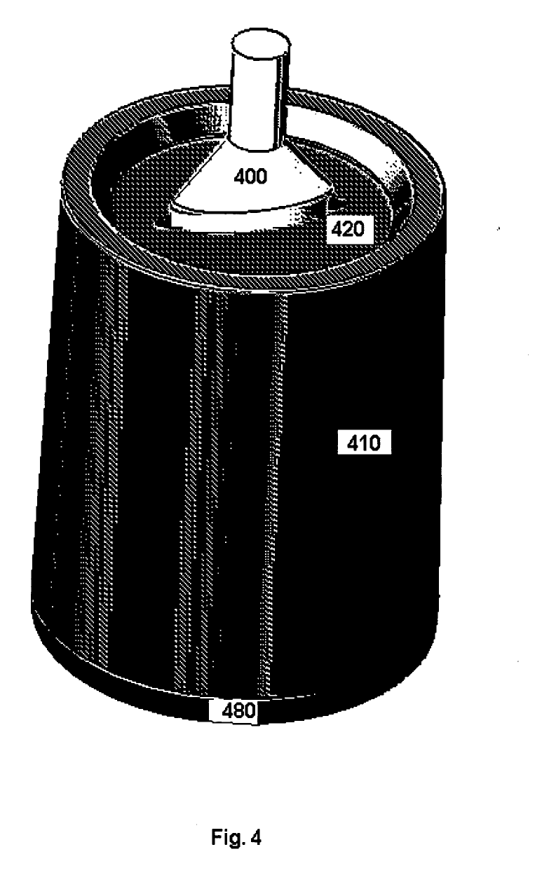

FIG. 4 is a perspective view of a fully assembled unit and is presented to offer a clear image of an assembled unit. Parts showing are the outer frame 410 the top of the work piece holding device 420 and the outside of the base 480. For illustrative purposes only, and not a part of the current invention, a bottle of fingernail polish is shown properly loaded into the work piece holding device 420.

It is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Although the present invention has been described with reference to preferred embodiments, persons skilled in the art will recognize that changes may be made in form and detail without departing from the spirit and scope of the invention.

1. A novel fingernail polish mixing system, comprising:
an elastomeric mixing platform sub-assembly, comprising a platform suspended across a plane by two or more elastic bands, a source of vibration or gyration and a counter dampening device.

2. A novel fingernail polish mixing system wherein the work piece holding device is comprised of a cylindrical foam plug with a cut out cavity the shape of which is optimal for receiving and holding common fingernail polish bottles securely during mixing by virtue of elastic counter reaction to said bottle insertion.

3. The fingernail polish mixing system of claim 1, wherein a motor with a counter weighted rotational shaft is used as a source of initial vibration or gyration to initiate mixing action.

4. The fingernail polish mixing system of claim 1, wherein the work piece holding device is comprised of a cylindrical foam plug with a cut out cavity the shape of which is optimal for receiving and holding common fingernail polish bottles securely during mixing by virtue of elastic counter reaction to said bottle insertion.

5. The fingernail polish mixing system of claim 2, wherein a motor with counter weighted rotational shaft is used as a source of initial vibration or gyration to perform the mixing action.

6. The fingernail polish mixing system of claim 4, wherein a motor with counter weighted rotational shaft is used as a source of initial vibration or gyration to perform the mixing.

7. The fingernail polish mixing system of claim 2, wherein the work piece holding device serves as a physical travel limit to the gyration of the mixing platform thereby limiting the formation of undesirable air bubbles within the solution being mixed.

8. The fingernail polish mixing system of claim 6, wherein the motor used is a permanent magnet DC motor.

9. The fingernail polish mixing system of claim 6, wherein the mixing cycle is automatically triggered by the insertion of the bottle of fingernail polish.

10. The fingernail polish mixing system of claim 6, wherein the mixing cycle is automatically triggered by the insertion of the bottle of fingernail polish by means of a permanent magnet and a magnetic reed switch.

11. The fingernail polish mixing system of claim 6, wherein the mixing cycle may be triggered by a single hand during and coincidental to the insertion of a bottle of fingernail polish.

12. The fingernail polish mixing system of claim 9, wherein the mixing gyration is such that it limits the formation of air bubbles within the nail polish or solution being mixed.

13. The fingernail polish mixing system of claim 10, wherein the mixing gyration is such that it limits the formation of air bubbles within the nail polish or solution being mixed.

14. The fingernail polish mixing system of claim 12 wherein the mixing cycle is controlled by an electronic timer circuit.

15. The fingernail polish mixing system of claim 14 wherein the mixing cycle is controlled by an electronic timer circuit which is capable of also reversing motor rotation during the mixing cycle.

16. The fingernail polish mixing system of claim 15 wherein an optional battery eliminator may be attached, allowing the mixing unit to be powered by common household power sources.

17. The fingernail polish mixing system of claim 16 wherein the batteries may be of the rechargeable type and the battery eliminator is also a battery charger.

18. The fingernail polish mixing system of claim 4 wherein the work piece holding device acts as a counter dampener to the vibration or gyration source.
